(19) United States
(12) Patent Application Publication
(10) Pub. No.: US 2026/0073166 A1
(43) Pub. Date: Mar. 12, 2026

(54) WIRELESS TAG COMMUNICATION APPARATUS AND WIRELESS TAG COMMUNICATION METHOD

(71) Applicant: Toshiba Tec Kabushiki Kaisha, Tokyo (JP)

(72) Inventors: Nanami SHINOZAKI, Sunto Shizuoka (JP); Hiroyuki ISHIKAWA, Sunto Shizuoka (JP)

(21) Appl. No.: 19/235,225

(22) Filed: Jun. 11, 2025

(30) Foreign Application Priority Data
Sep. 9, 2024 (JP) 2024-154886

(51) Int. Cl. G06K 7/10; G01S 5/02; G06K 19/07

(52) U.S. Cl. CPC G06K 7/10128; G01S 5/0284; G06K 19/0723

(57) ABSTRACT

According to an embodiment, a wireless tag communication apparatus reads, on the basis of a radio wave received by an antenna, tag data of a wireless tag including an identification code of an article. The wireless tag communication apparatus performs, on the basis of a scheduled list that is a list of identification codes of articles to be disposed in a disposed region and a read list that is a list of read identification codes of articles, warning processing indicating a possibility that an article disposed in the disposed region is different from any of the articles corresponding to the identification codes in the scheduled list.

### CROSS-REFERENCE TO RELATED APPLICATIONS

This application is based upon and claims the benefit of priority from the prior Japanese Patent Application No. 2024-154886, filed on Sep. 9, 2024, the entire contents of which are incorporated herein by reference.

### FIELD

An embodiment to be described here generally relates to a wireless tag communication apparatus and a wireless tag communication method.

### BACKGROUND

In recent years, wireless tags have been increasingly used to perform accounting processing, inspection processing, and the like. In such a system, a wireless tag is attached to an article or a product and a wireless tag communication apparatus detects the wireless tag to read information from the wireless tag. The wireless tag transmits, upon receiving a radio wave from the wireless tag communication apparatus, a radio wave in response thereto. The wireless tag communication apparatus emits a radio wave from an antenna and receives, by the antenna, the radio wave transmitted from the wireless tag in response thereto, thereby detecting the wireless tag to read the information from the wireless tag. Further, the wireless tag communication apparatus transmits/receives radio waves while changing the relative position of the antenna to the wireless tag, and reads information from the wireless tag at a plurality of relative positions of the antenna to the wireless tag, thereby inferring the disposed region of the wireless tag. As a method of inferring the disposed region of the wireless tag, a method based on the phase difference that is a change in phase, a method using a trained model by machine learning, and the like are known.

For example, in inspection processing when shipping, the wireless tag communication apparatus reads information from the wireless tag to infer the disposed region of the wireless tag, but the reading or inference is not performed correctly in some times. It is unclear to the user whether or not the reading or inference has been performed correctly.

### BRIEF DESCRIPTION OF THE DRAWINGS

FIG. 1 is a block diagram showing a configuration example of a wireless tag communication apparatus according to an embodiment.

FIG. 2 is a diagram showing a configuration example of a relative position change device shown in FIG. 1.

FIG. 3 is a diagram showing another configuration example of the relative position change device shown in FIG. 1.

FIG. 4 is a diagram showing still another configuration example of the relative position change device shown in FIG. 1.

FIG. 5 is a diagram showing a hardware configuration of a computer constituting a reading device, an inferring device, the relative position change device, and a terminal shown in FIG. 1.

FIG. 6 is a flowchart showing a first operation example of the wireless tag communication apparatus according to the embodiment.

FIG. 7 is a flowchart showing an operation example of read processing shown in FIG. 6.

FIG. 8 is a flowchart showing an operation example of inference processing shown in FIG. 6.

FIG. 9 is a flowchart showing another operation example of the inference processing shown in FIG. 6.

FIG. 10 is a flowchart showing a first operation example of warning processing shown in FIG. 6.

FIG. 11 is a diagram schematically showing a flow of an example of comparison between an in-region list an in-region list and a scheduled list and creation of a shortage list in the first operation example of the warning processing shown in FIG. 6.

FIG. 12 is a diagram schematically showing a disposition example of wireless tags corresponding to the flow of processing shown in FIG. 11.

FIG. 13 is a flowchart showing a second operation example of the warning processing shown in FIG. 6.

FIG. 14 is a diagram schematically showing a flow of an example of comparison between an in-region list and a scheduled list, creation of a shortage list, and comparison between the shortage list and an outside-region list in the second operation example of the warning processing shown in FIG. 13.

FIG. 15 is a diagram schematically showing a disposition example of wireless tags corresponding to the flow of processing shown in FIG. 14.

FIG. 16 is a diagram schematically showing a flow of an example of comparison between an in-region list and a scheduled list, creation of a shortage list, and comparison between the shortage list and an outside-region list in the second operation example of the warning processing shown in FIG. 13.

FIG. 17 is a diagram schematically showing a disposition example of wireless tags corresponding to the flow of processing shown in FIG. 16.

FIG. 18 is a diagram schematically showing a flow of an example of comparison between an in-region list and a scheduled list and creation of an excess list in the second operation example of the warning processing shown in FIG. 13.

FIG. 19 is a diagram schematically showing a disposition example of wireless tags corresponding to the flow of processing shown in FIG. 18.

FIG. 20 is a flowchart showing a second operation example of the wireless tag communication apparatus according to the embodiment.

FIG. 21 is a flowchart showing an operation example of warning processing shown in FIG. 20.

FIG. 22 is a diagram schematically showing a flow of an example of comparison between a scheduled list and a read list and creation of a shortage list in the operation example of the warning processing shown in FIG. 20.

FIG. 23 is a diagram schematically showing a disposition example of wireless tags corresponding to the flow of processing shown in FIG. 22.

FIG. 24 is a diagram schematically showing a first modification of the operation example of the warning processing of the wireless tag communication apparatus according to the embodiment.

FIG. 25 is a diagram schematically showing a second modification of the operation example of the warning processing of the wireless tag communication apparatus according to the embodiment.

FIG. 26 is a diagram schematically showing a third modification of the operation example of the warning processing of the wireless tag communication apparatus according to the embodiment.

### DETAILED DESCRIPTION

According to an embodiment, a wireless tag communication apparatus includes: an antenna; a reading device; and a warning device. The antenna reads a radio wave transmitted from a wireless tag attached to an article. The reading device reads, on the basis of the radio wave received by the antenna, tag data of the wireless tag including an identification code of the article. The warning device performs, on the basis of a scheduled list that is a list of identification codes of articles to be disposed in a disposed region for shipment and a read list that is a list of identification codes of articles read by the reading device, warning processing indicating a possibility that an article disposed in the disposed region is different from any of the articles corresponding to the identification codes in the scheduled list.

An embodiment will be described below with reference to the drawings. In each drawing, the configuration is omitted or simplified as appropriate in some cases for the sake of description. In the drawings, the same reference symbols will denote the same or similar portions.

### (Wireless Tag Communication Apparatus)

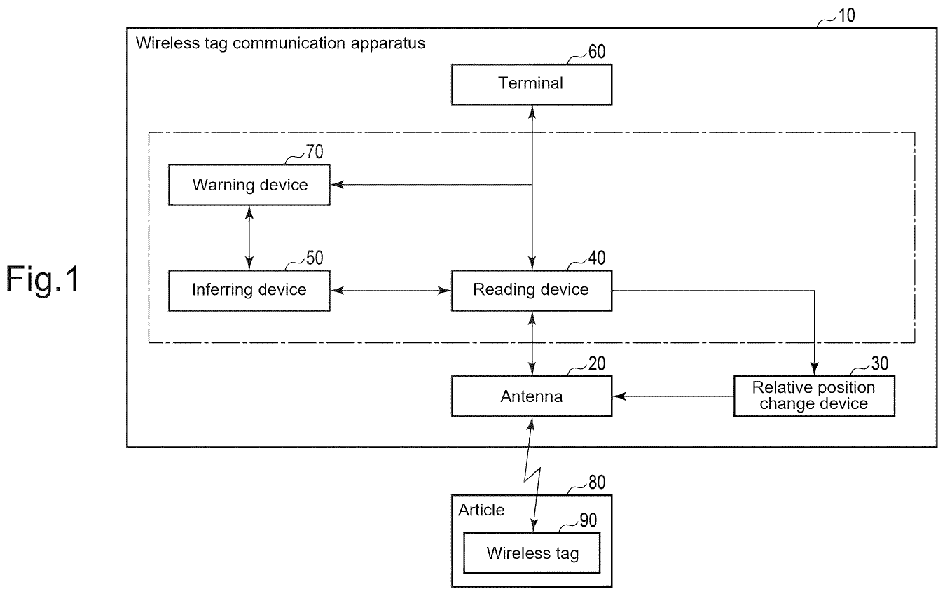

A wireless tag communication apparatus 10 according to an embodiment will be described first with reference to FIG. 1. FIG. 1 is a block diagram showing a configuration example of the wireless tag communication apparatus 10 according to the embodiment.

The wireless tag communication apparatus 10 reads tag data from a wireless tag 90 attached to an article 80 such as a product, infers the disposed region of the wireless tag 90 from the read tag data, and performs processing according to the use on each wireless tag 90 in the inferred disposed region. For example, the wireless tag communication apparatus 10 performs, in the case where an article disposed in a disposed region for shipment is different from any of these in a scheduled list, warning processing to alert.

FIG. 1 shows one article 80 and one wireless tag 90 for the sake of convenience, but this is not intended to indicate the number of articles 80 and the number of wireless tags 90. The number of articles 80 and the number of wireless tags 90 may each be one or more, and are often more than one. One wireless tag 90 is attached to one article 80.

The wireless tag communication apparatus 10 includes an antenna 20, a relative position change device 30, a reading device 40, an inferring device 50, a terminal 60, and a warning device 70.

The antenna 20 is a device for communicating with the wireless tag 90. The antenna 20 emits a radio wave. Further, the antenna 20 receives a radio wave transmitted from the wireless tag 90 in response to the emitted radio wave. The antenna 20 converts the radio wave received from the wireless tag 90 into a high frequency signal and outputs the high frequency signal to the reading device 40.

The relative position change device 30 changes the relative position of the antenna 20 to the wireless tag 90. The configuration example of the relative position change device 30 will be described below.

The reading device 40 controls the antenna 20 and the relative position change device 30 to read, on the basis of the radio wave that is transmitted from the wireless tag 90 and received by the antenna 20, the tag data including the identification code of the wireless tag 90. In detail, the reading device 40 reads the tag data of the wireless tag 90 at a plurality of relative positions of the antenna 20 to the wireless tag 90.

The identification code of the wireless tag 90 is also the identification code of the article to which the wireless tag 90 is attached. That is, the identification code of the wireless tag 90 and the identification code of the article are synonymous with each other.

The inferring device 50 infers the disposed region of the wireless tag 90 from the tag data of the wireless tag 90 at the plurality of relative positions of the antenna 20 to the wireless tag 90 read by the reading device 40. The inferring device 50 infers, for one disposed region, for example, whether the wireless tag 90 is in the disposed region or outside the disposed region. The number of disposed regions is not limited to one. That is, the inferring device 50 may infer, for a plurality of disposed regions, whether the wireless tag 90 is in the disposed regions or outside the disposed regions. The inferring device 50 performs the inference using a trained model by machine learning or on the basis of the phase difference of the received radio wave, for example.

The terminal 60 is a device that is an interface with a user (i.e., user interface). The terminal 60 receives a user's instruction for the wireless tag communication apparatus 10. The terminal 60 presents the user with the processing result of the wireless tag communication apparatus 10, for example, the reading result of the reading device 40 or the inference result of the inferring device 50.

Further, the terminal 60 processes the reading result of the reading device 40 and the inference result of the inferring device 50. In one example, the terminal 60 is a cash register terminal for performing accounting processing. Further, in another example, the terminal 60 is a mobile terminal to be used for picking when performing inspection processing. The present technology is not limited thereto, and the terminal 60 may be an arbitrary terminal for processing the reading result of the reading device 40 and the inference result of the inferring device 50 in accordance with the intended use.

The warning device 70 performs warning processing on the basis of the scheduled list and the read list. The scheduled list is a list of identification codes of the articles 80 to be disposed in the disposed region for shipment and is given in advance. The article 80 to be disposed in the disposed region is a product to be shipped, or the like. The read list is a list of identification codes of the wireless tag 90 read by the reading device 40 (i.e., identification codes of the articles 80). The warning processing is processing of comparing the scheduled list and the read list and alerting the user, as necessary, in the case where, for example, the scheduled list and the read list do not match, and includes, for example, an instruction to display a warning message on the terminal 60. The warning message is, for example, the content indicating a possibility that the article 80 to be shipped, which is disposed in the disposed region, is different from any of the articles 80 corresponding to the identification codes in the scheduled list. The warning processing may include, in addition to an instruction to display the warning message, making a warning sound, turning on or blinking a light-emitting element, and the like.

For example, the warning device 70 performs, in the case where at least one of the identification codes in the scheduled list is not included in the read list, warning processing indicating a shortage of the article 80 corresponding to the identification code that is included in the scheduled list but is not included in the read list.

Favorably, the warning device 70 performs warning processing using the inference result of the inferring device 50 obtained from the reading result of the reading device 40. For example, the warning device 70 creates an in-region list that is a list of identification codes of the articles 80 inferred to be in the disposed region, compares the in-region list with the scheduled list, and performs, in the case where the scheduled list and the in-region list do not match, warning processing indicating a possibility that the article 80 to be shipped is different from any of the articles 80 in the scheduled list.

Further, the warning device 70 extracts an identification code that is included in the scheduled list but is not included in the in-region list to create a shortage list that is a list of identification codes of missing articles 80, and performs warning processing indicating the shortage of the article 80 corresponding to the identification code in the shortage list.

Further, the warning device 70 creates an outside-region list that is a list of identification codes of the articles 80 inferred to be outside the disposed region, compares the outside-region list with the shortage list, and performs, in the case where the identification code in the shortage list is included in the outside-region list, warning processing indicating a possibility that the article 80 corresponding to the identification code in the shortage list, which is included in the outside-region list, is nearby.

Further, the terminal 60 displays the warning message in accordance with the instruction to display the warning message from the warning device 70. The terminal 60 also makes a warning sound, and turns on or blinks a light-emitting element in accordance with an instruction from the warning device 70.

The article 80 is, for example, a product displayed in a store for sale, a product that is preserved in a warehouse or the like before shipping or after delivery during distribution, or a shipping box or the like in which the product is put. The present technology is not limited thereto, and the article 80 may be an arbitrary article that is managed using the wireless tag 90.

The wireless tag 90 is, for example, a radio frequency identification (RFID) tag. The present technology is not limited thereto, and the wireless tag 90 may be another wireless tag. For example, the wireless tag 90 is a passive wireless tag that operates using the radio wave transmitted from the antenna 20 as its energy source. The wireless tag 90 transmits a signal including the tag data stored in the wireless tag 90 by performing backscatter modulation on an unmodulated signal. The tag data stored in the wireless tag 90 includes identification tag data that can be uniquely identified. For example, the tag data stored in the wireless tag 90 includes the identification code of the article 80 (product or shipping box) to which the wireless tag 90 is attached.

### (Configuration Example of Relative Position Change Device)

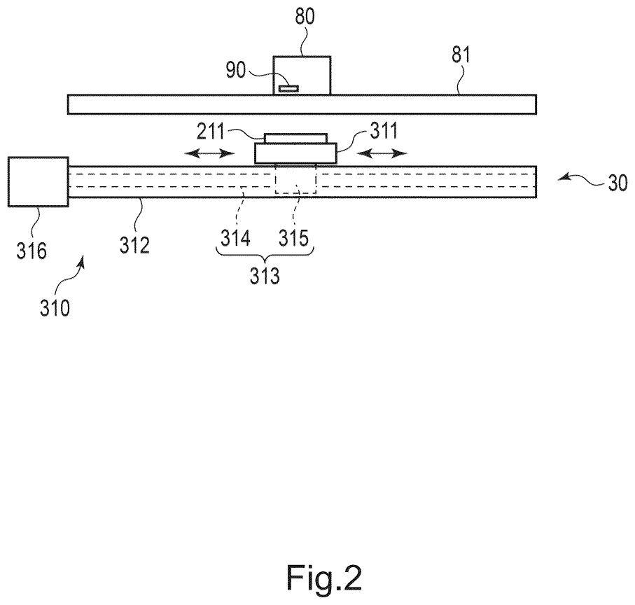

Next, a configuration example of the relative position change device 30 will be described with reference to FIG. 2. FIG. 2 is a diagram showing a configuration example of the relative position change device 30 of the wireless tag communication apparatus 10.

In the configuration example of the relative position change device 30 shown in FIG. 2, the antenna 20 includes one antenna 211. The antenna 20 is installed below a table 81 on which the article 80 to which the wireless tag 90 is attached is placed.

The relative position change device 30 includes a moving mechanism 310 that causes the antenna 211 to move. The moving mechanism 310 is a linear motion mechanism that causes the antenna 211 to linearly move. The moving mechanism 310 includes a stage 311, a guide rail 312, and a driving device 316. The stage 311 holds the antenna 211. The guide rail 312 holds the stage 311 such that the stage 311 is capable of moving linearly. The guide rail 312 includes a ball screw 313 inside. The ball screw 313 includes a rotatable screw shaft 314 and a nut 315 that is capable of moving along the screw shaft 314 in conjunction with the rotation of the screw shaft 314. The nut 315 holds the stage 311. The driving device 316 causes the screw shaft 314 to rotate. The rotational movement of the screw shaft 314 is converted into linear movement of the nut 315. For this reason, when the driving device 316 causes the screw shaft 314 to move, the antenna 211 held by the stage 311 is caused to move linearly.

The driving device 316 is controlled by the reading device 40. The driving device 316 is, for example, a stepping motor. The reading device 40 controls the change in relative position of the antenna 211 to the wireless tag 90, i.e., linear movement, by controlling the stepping motor that is the driving device 316.

### (Another Configuration Example of Relative Position Change Device)

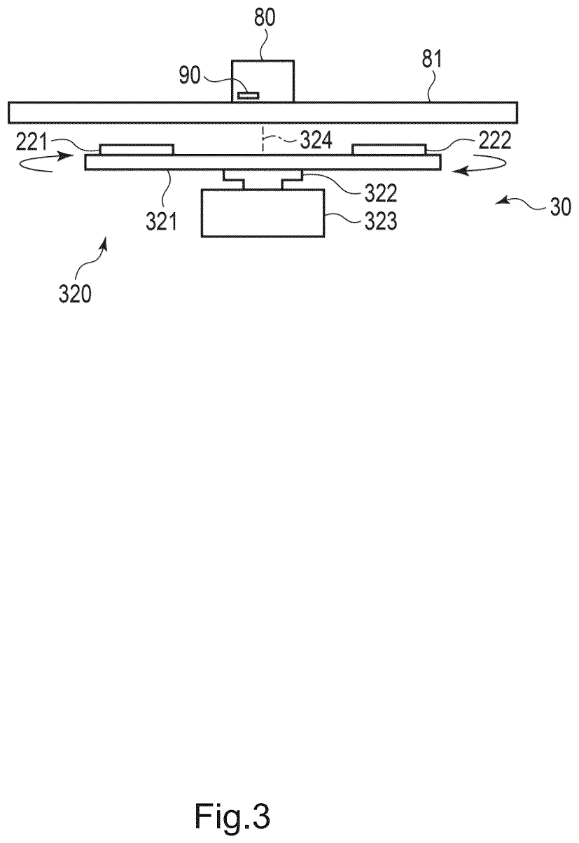

Subsequently, another configuration example of the relative position change device 30 will be described with reference to FIG. 3. FIG. 3 is a diagram showing another configuration example of the relative position change device 30 of the wireless tag communication apparatus 10.

In the configuration example of the relative position change device 30 shown in FIG. 3, the antenna 20 includes two antennas 221 and 222. The antennas 221 and 222 are installed below the table 81 on which the article 80 to which the wireless tag 90 is attached is placed.

The relative position change device 30 includes a moving mechanism 320 that causes the antennas 221 and 222 to move. The moving mechanism 320 is a rotating mechanism that causes the antennas 221 and 222 to move around a rotation center axis 324. The moving mechanism 320 includes a stage 321, a holding unit 322, and a driving device 323. The stage 321 holds the antennas 221 and 222. The holding unit 322 holds the stage 321 rotatably. The driving device 323 causes the holding unit 322 to rotate around the rotation center axis 324. For this reason, when the driving device 323 causes the holding unit 322 holding the stage 321 to rotate, the antennas 221 and 222 held by the stage 321 are caused to rotate and move around the rotation center axis 324.

The driving device 323 is controlled by the reading device 40. The driving device 323 is, for example, a stepping motor. The reading device 40 controls the change in relative positions of the antennas 221 and 222 to the wireless tag 90, i.e., rotational movement, by controlling the stepping motor that is the driving device 323.

### (Still Another Configuration Example of Relative Position Change Device)

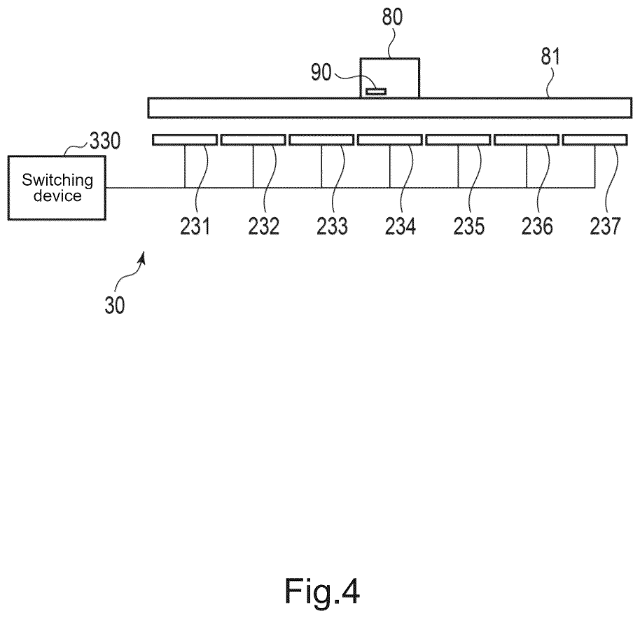

Next, still another configuration example of the relative position change device 30 will be described with reference to FIG. 4. FIG. 4 is a diagram showing still another configuration example of the relative position change device 30 of the wireless tag communication apparatus 10.

In the configuration example of the relative position change device 30 shown in FIG. 4, the antenna 20 includes a plurality of antennas, e.g., seven antennas 231 to 237. The antennas 231 to 237 are installed below the table 81 on which the article 80 to which the wireless tag 90 is attached is placed. The number of antennas 231 to 237 is not limited thereto and only needs to be more than one, but the larger the better.

The relative position change device 30 includes a switching device 330 that switches the antennas 231 to 237. For example, the switching device 330 switches between on and off of the transmission function and the reception function of the antennas 231 to 237. That is, the switching device 330 is capable of transmitting and receiving radio waves using an arbitrary antenna of the antennas 231 to 237.

The switching device 330 is controlled by the reading device 40. For example, the reading device 40 transmits and receives radio waves using one of the antennas 231 to 237 at a time and controls the switching device 330 such that the antenna that transmits and receives radio waves is switched over time. For example, the reading device 40 controls the switching device 330 such that the antenna that transmits and receives radio waves is switched along the array of the antennas 231 to 237. The reading device 40 controls the change in relative positions of the antennas 231 to 237 to the wireless tag 90 by switching the antenna that transmits and receives radio waves.

### (Hardware Configuration)

The reading device 40, the inferring device 50, the terminal 60, and the warning device 70 of the wireless tag communication apparatus 10 are configured by, for example, a computer. The computer includes, for example, a personal computer, a server computer, or a tablet.

In one example, the reading device 40, the inferring device 50, the terminal 60, and the warning device 70 are configured by one computer. The reading device 40, the inferring device 50, the terminal 60, and the warning device 70 may each be configured one computer. For example, the terminal 60 may be configured by one computer and may wirelessly communicate with another computer constituting the reading device 40, the inferring device 50, and the warning device 70.

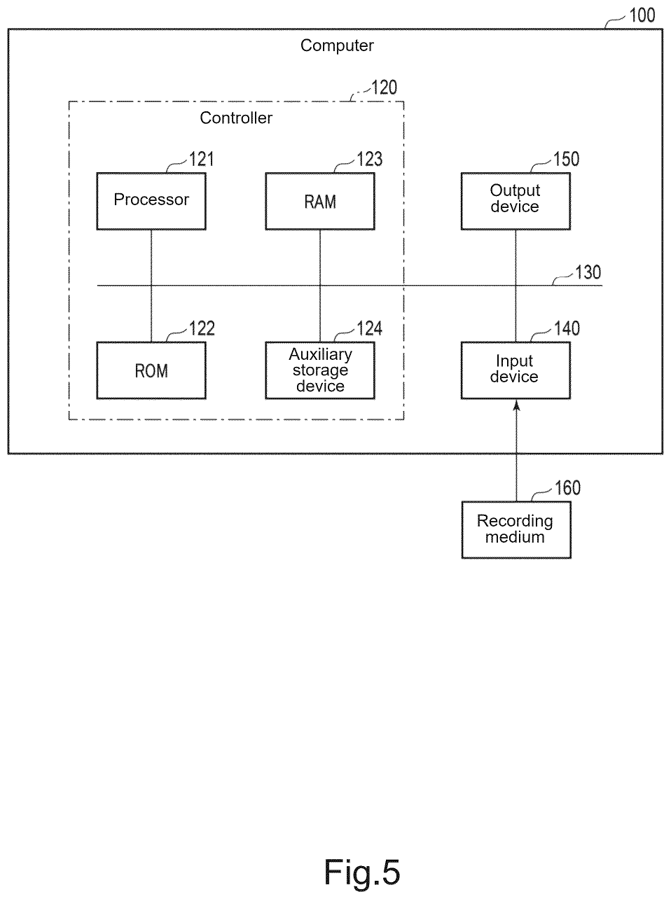

A hardware configuration example of a computer 100 constituting the reading device 40, the inferring device 50, the terminal 60, and the warning device 70 will be described with reference to FIG. 5. FIG. 5 is a block diagram showing a hardware configuration example of the computer 100 constituting the reading device 40, the inferring device 50, the terminal 60, and the warning device 70.

The computer 100 includes a controller 120, an input device 140, and an output device 150.

The controller 120 controls the entire computer 100. The controller 120 includes a processor 121, a read only memory (ROM) 122, a random access memory (RAM) 123, and an auxiliary storage device 124.

The processor 121, the ROM 122, the RAM 123, the auxiliary storage device 124, the input device 140, and the output device 150 are electrically connected to each other via a bus 130 and are capable of transmitting/receiving data to/from each other.

The processor 121 includes, for example, a general-purpose hardware processor including a central processing unit (CPU) and a graphical processing unit (GPU). The processor 121 executes the program developed into the RAM 123, thereby executing various functions of the computer 100.

The ROM 122 is a non-volatile memory constituting part of the main storage device. The ROM 122 non-temporarily stores the startup program necessary for starting up the computer 100. The processor 121 develops the startup program in the ROM 122 into the RAM 123 and executes the program, thereby starting up the computer 100. The ROM 122 includes, for example, an erasable programmable read only memory (EPROM) and is capable of storing various settings at the time of startup in addition to the startup program.

The RAM 123 is a volatile memory constituting part of the main storage device. The RAM 123 temporarily stores the program necessary for the processor 121 to process and data necessary for executing the program. That is, the RAM 123 functions as a work area of the processor 121.

The auxiliary storage device 124 includes a non-volatile memory such as a hard disk drive (HDD) and a solid state drive (SSD). The auxiliary storage device 124 is capable of non-temporarily storing various programs to be executed by the processor 121 and data necessary for executing the programs. The processor 121 develops the program in the auxiliary storage device 124 into the RAM 123 and executes the program, thereby executing various functions of the computer 100.

The input device 140 is a device for a user to input information and an instruction, and receives an input of information and an instruction. The input device 140 includes a keyboard, a pointing device, and the like. The pointing device includes a mouse, a track pad, a touch screen, and the like. The input device 140 also includes a sensor. The sensor includes a position sensor, a camera, and the like. For example, in the case where the relative position change device 30 has the configuration example shown in FIG. 2 or FIG. 3, the position sensor includes a home position sensor that detects that the antenna 211, 221, or 222 is at the initial position (home position).

The output device 150 is a device that outputs information to provide information to a user. The output device 150 is, for example, a display device and displays characters, images, and the like on a screen. For example, the output device 150 is a liquid crystal display, an organic EL display, a plasma display, or the like. The output device 150 is also, for example, a sound output device and includes a speaker or the like that outputs sound. The output device 150 is also, for example, a light-emitting device that reports abnormalities using light and includes various light-emitting devices such as LEDs.

The input device 140 and the output device 150 may be configured as an input/output device having both functions. Such an input/output device may include, for example, a touch panel display.

Further, the input device 140 may also include a device that captures information and data from the outside. For example, the input device 140 may include a wired or wireless interface or reception device.

Further, the output device 150 may also include a device that outputs information and data to the outside. For example, the output device 150 may include a wired or wireless interface or transmission device.

Further, the input device 140 may also include a device that reads data from a computer-readable recording medium 160 that has non-temporarily recorded data such as a program. For example, the recording medium 160 includes a disc such as a flexible disc, an optical disc (CD-ROM, CD-R, DVD-ROM, DVD-R, etc.), and a magneto-optical disc (MO, etc.), or a semiconductor memory. The input device 140 includes a drive, a reader, and the like therefor.

The program to be stored in the auxiliary storage device 124 is provided to the computer 100 via the recording medium 160, for example. Further, the program may be stored on a server on a network and downloaded to be provided to the computer 100.

For example, the processor 121 executes, when the computer 100 starts up, the startup program in the ROM 122 to start up the operating system (OS). The processor 121 monitors an instruction input, connection of an external device, and the like under the control of the OS. Further, the processor 121 sets a program area and a data area in the RAM 123 under the control of the OS.

In response to the instruction input to start up the program, the processor 121 reads the program from the auxiliary storage device 124 into the program area of the RAM 123 and reads the data necessary for executing the program from the auxiliary storage device 124 into the data area of the RAM 123. The processor 121 calculates the data in the data area in accordance with the program and writes the calculation result to the data area.

By such an operation, the processor 121, the RAM 123, and the auxiliary storage device 124 cooperate to execute at least part of the function of the controller 120. Further, the controller 120, the input device 140, and the output device 150 cooperate to execute at least part of the function of the computer 100.

The program that is non-temporarily stored in the auxiliary storage device 124 includes a program for causing the processor 121 to execute at least part of the function of the controller 120. In other words, the processor 121 executes at least part of the function of the controller 120 by executing this program.

For example, the program that is non-temporarily stored in the auxiliary storage device 124 includes a wireless tag communication program that causes the computer 100 to execute at least part of the functions of the reading device 40, the inferring device 50, the terminal 60, and the warning device 70 of the wireless tag communication apparatus 10. When the processor 121 executes the wireless tag communication program, the controller 120 cooperate with the input device 140 and the output device 150 to execute at least part of the functions of the reading device 40, the inferring device 50, the terminal 60, and the warning device 70 of the wireless tag communication apparatus 10.

### (First Operation Example of Wireless Tag Communication Apparatus)

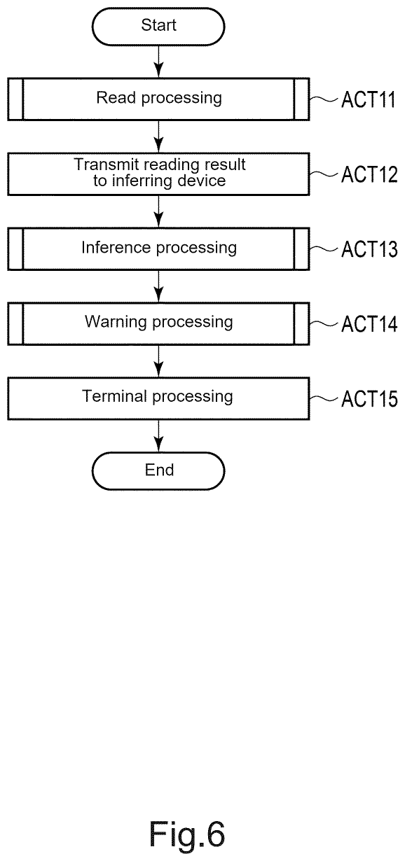

Next, a first operation example of the wireless tag communication apparatus 10 will be described with reference to FIG. 6. FIG. 6 is a flowchart showing a first operation example of the wireless tag communication apparatus 10. The first operation example shown in FIG. 6 is an operation example in which warning processing is performed on the basis of the inference result of the inferring device 50. The flowchart shown in FIG. 6 is started by, for example, inputting an operation start instruction to the terminal 60.

In ACT11, the reading device 40 performs read processing. The reading device 40 reads the tag data from the wireless tag 90 while the relative position change device 30 changes the relative position of the antenna 20 to the wireless tag 90. As a result, the reading device 40 reads the tag data of the wireless tag 90 at a plurality of relative positions of the antenna 20 to the wireless tag 90.

In ACT12, the reading device 40 transmits the read tag data of the wireless tag 90 to the inferring device 50.

In ACT13, the inferring device 50 performs inference processing. The inferring device 50 infers the disposed region of each wireless tag 90 from the tag data of the wireless tag 90 read by the reading device 40. For example, the inferring device 50 infers whether each wireless tag 90 is in the disposed region or outside the disposed region. The method of the inference will be described below. The inferring device 50 transmits the inference result to the warning device 70.

In ACT14, the warning device 70 performs warning processing. For example, the warning device 70 creates an in-region list that is a list of identification codes of the articles 80 inferred to be in the disposed region, compares the in-region list with the scheduled list, and transmits, to the terminal 60, an instruction to display a warning message in accordance with the comparison result.

In ACT15, the terminal 60 performs terminal processing. For example, the terminal 60 displays a warning message in accordance with the instruction display a warning message received from the warning device 70.

### (Operation Example of Read Processing)

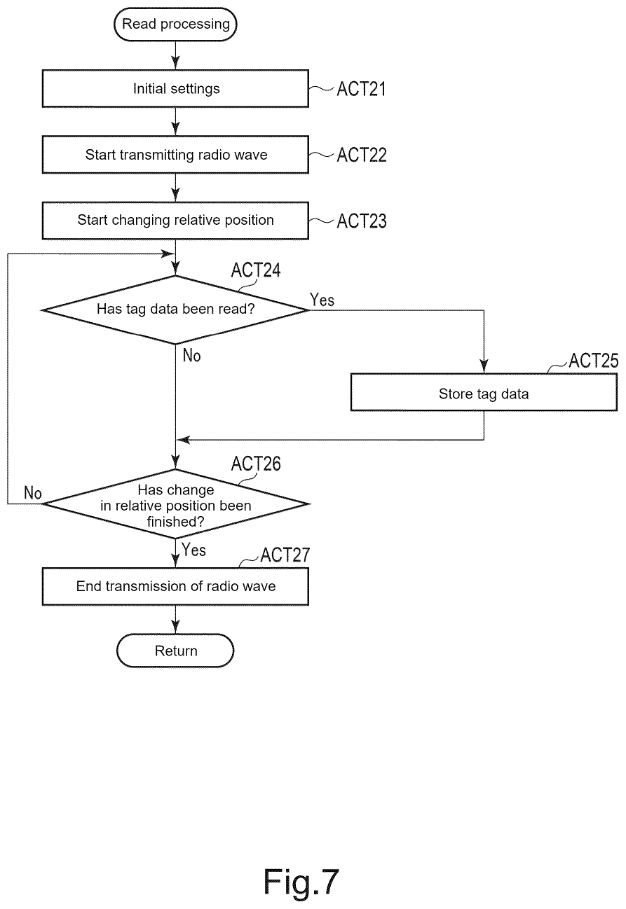

Next, an operation example of the read processing shown in FIG. 6 will be described with reference to FIG. 7. FIG. 7 is a flowchart showing an operation example of the read processing shown in FIG. 6.

First, the reading device 40 performs initial setting processing in ACT21 as necessary. For example, the initial setting processing includes processing of disposing the antenna 211, 221, or 222 at the initial position in the case where the relative position change device 30 has a configuration example of including, for example, the moving mechanism 310 that causes the antenna 211 to move as shown in FIG. 2 or the moving mechanism 320 that causes the antennas 221 and 222 to move as shown in FIG. 3.

Next, in ACT22, the reading device 40 starts transmitting a radio wave via the antenna 20. At this time, the reading device 40 transmits a radio wave with an output that ensures that the wireless tag 90 in the disposed region responds.

Subsequently, in ACT23, the relative position change device 30 changes the relative position of the antenna 20 to the wireless tag 90.

In the case where the tag data of the wireless tag 90 has been successfully read in ACT24 (Yes in ACT24), the reading device 40 stores the read tag data of the wireless tag 90 in ACT25.

After storing the tag data in the case where the tag data of the wireless tag 90 has been successfully read (Yes in ACT24), or in the case where the tag data of the wireless tag 90 has failed to be read (No in ACT24), the reading device 40 determines whether or not the change in relative position of the antenna 20 to the wireless tag 90 has been finished in ACT26 and repeatedly performs the processing of ACT24 and ACT25 until the change in relative position of the antenna 20 to the wireless tag 90 is finished (during No in ACT26).

When the change in relative position of the antenna 20 to the wireless tag 90 has been finished (in the case of Yes in ACT26), the reading device 40 ends the transmission of the radio wave in ACT27.

### (Operation Example of Inference Processing)

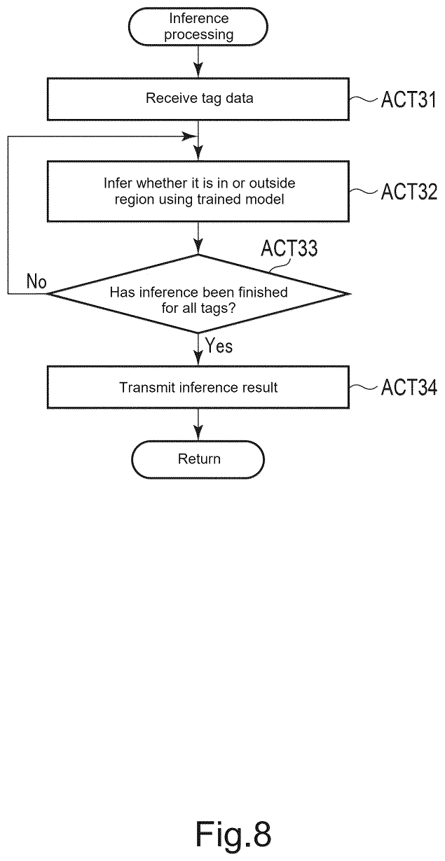

Next, an operation example of the inference processing shown in FIG. 6 will be described with reference to FIG. 8. FIG. 8 is a flowchart showing an operation example of the inference processing shown in FIG. 6. This operation example is an example in which whether the wireless tag 90 is in the disposed region or outside the disposed region is inferred using a trained model by machine learning.

In ACT31, the inferring device 50 receives the tag data of the wireless tag 90 from the reading device 40.

In ACT32, the inferring device 50 infers whether each wireless tag 90 is in the disposed region or outside the disposed region from the received tag data at a plurality of relative positions of each wireless tag 90 using a trained model by machine learning.

The inferring device 50 repeats the inference of ACT32 for all of the wireless tags 90 until the inference is finished (during No in ACT33).

When the inference is finished for all of the wireless tags 90 (in the case of Yes in ACT33), the inferring device 50 transmits the inference result to the warning device 70 in ACT34.

### (Another Operation Example of Inference Processing)

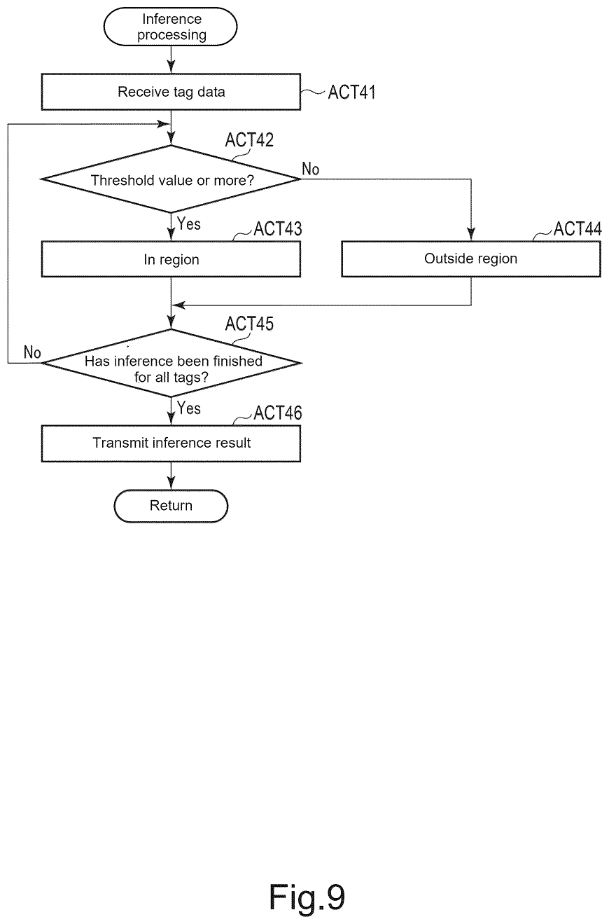

Next, another operation example of the inference processing shown in FIG. 6 will be described with reference to FIG. 9. FIG. 9 is a flowchart showing another operation example of the inference processing shown in FIG. 6. This operation example is an example in which whether the wireless tag 90 is in the disposed region or outside the disposed region is inferred on the basis of the phase difference of the radio wave received by the antenna 20.

In ACT41, the inferring device 50 receives the tag data of the wireless tag 90 from the reading device 40.

In ACT42, the inferring device 50 calculates a phase difference, which is a change in phase of the received tag data with respect to the change in relative position at a plurality of relative positions of each wireless tag 90, and determines whether or not the phase difference is a threshold value or more.

In the case where the phase difference is the threshold value or more (in the case of Yes in ACT42), the inferring device 50 infers that the wireless tag 90 is in the disposed region in ACT43.

On the contrary, in the case where the phase difference is less than the threshold value (in the case of No in ACT42), the inferring device 50 infers that the wireless tag 90 is outside the disposed region in ACT44.

The inferring device 50 repeats the inference of ACT42 to ACT44 until the inference is finished for all of the wireless tags 90 (during No in ACT45).

When the inference is finished for all of the wireless tags 90 (in the case of Yes in ACT45), the inferring device 50 transmits the inference result to the warning device 70 in ACT46.

### (First Operation Example of Warning Processing)

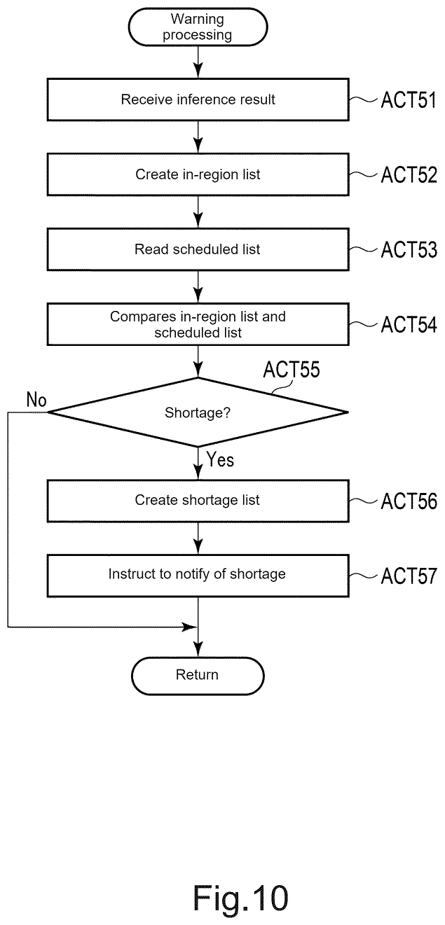

Next, a first operation example of the warning processing shown in FIG. 6 will be described with reference to FIG. 10. FIG. 10 is a flowchart showing the first operation example of the warning processing shown in FIG. 6.

First, in ACT51, the warning device 70 receives an inference result from the inferring device 50.

Next, in ACT52, the warning device 70 creates an in-region list on the basis of the inference result received from the inferring device 50. The in-region list is a list of identification codes of the wireless tags 90 inferred to be in the disposed region by the inferring device 50.

Subsequently, in ACT53, the warning device 70 reads a scheduled list. The scheduled list is a list of identification codes of the articles 80 to be disposed in the disposed region for shipment. The scheduled list is given in advance.

Next, the warning device 70 compares the in-region list and the scheduled list in ACT54, and determine whether or not there is a shortage of identification codes of the wireless tags 90 in the in-region list (i.e., identification codes of the articles 80) with respect to the identification codes of the articles 80 in the scheduled list in ACT55.

In the case where the result of the determination in ACT55 is that there is a shortage of identification codes of the wireless tags 90 in the in-region list (in the case of Yes in ACT55), the warning device 70 extracts an identification code that is included in the scheduled list but is not included in the in-region list to create a shortage list that is a list of identification codes of missing articles 80 in ACT56.

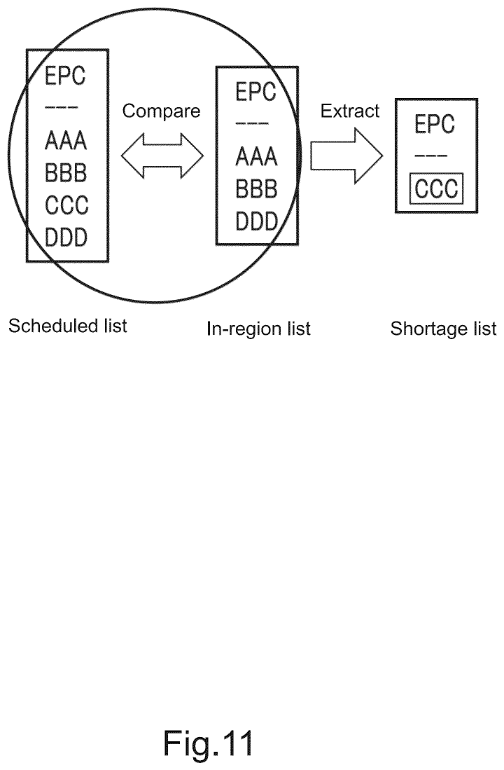

A flow of an example of the comparison between the scheduled list and the in-region list in ACT54 and the creation of a shortage list in ACT56 is schematically shown in FIG. 11. In FIG. 11, the identification code of the wireless tag 90 is shown as an electronic product code (EPC). The EPC is an identification code for identifying articles using an RFID technology.

FIG. 11 shows an example in which the EPC “CCC” that is included in the scheduled list but is not included in the in-region list is extracted as a result of the comparison between the scheduled list and the in-region list and a shortage list including the EPC “CCC” is created.

In ACT57, the warning device 70 instructs the terminal 60 to notify of the shortage. For this purpose, the warning device 70 transmits, to the terminal 60, an instruction to display a warning message indicating the shortage of the article 80 corresponding to the identification code in the shortage list. In ACT15 (terminal processing), the terminal 60 displays the warning message in accordance with the instruction to display the warning message received from the warning device 70.

The possible causes of that there is a shortage of identification codes in the in-region list with respect to the identification codes in the scheduled list include the following: the article 80 has not been in the disposed region; the reading device 40 has failed to read the wireless tag 90 correctly because the article 80 is located near the boundary within the disposed region; and the inferring device 50 has failed to perform inference correctly. The reasons why the article 80 is not in the disposed region include forgetting to take the article and a shortage of articles.

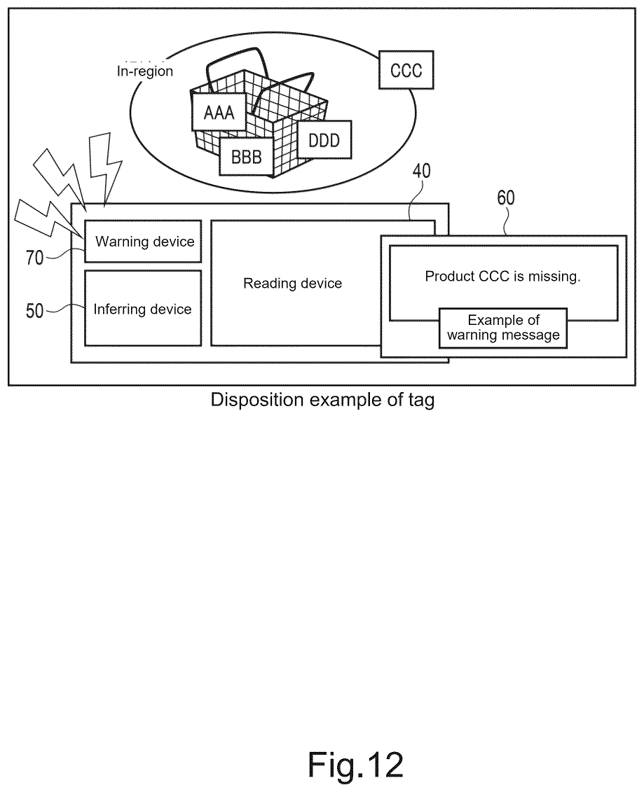

An example of the disposition of wireless tags and the warning message corresponding to the example shown in FIG. 11 is shown in FIG. 12. FIG. 12 shows an example in which there is a shortage of articles 80 in the in-region list with respect to the scheduled list because the article 80 with the EPC “CCC” is located near the boundary within the disposed region, and the terminal 60 displays the warning message “Product CCC is missing.” in accordance with an instruction from the warning device 70.

In the case where the result of the determination in ACT55 is that there is no shortage of identification codes of the wireless tags 90 in the in-region list (in the case of No in ACT55), the warning device 70 ends the warning processing without instructing the creation of a shortage list in ACT56 and the notification of a shortage in ACT57. In this case, the terminal 60 performs no processing in ACT15 (terminal processing).

### (Second Operation Example of Warning Processing)

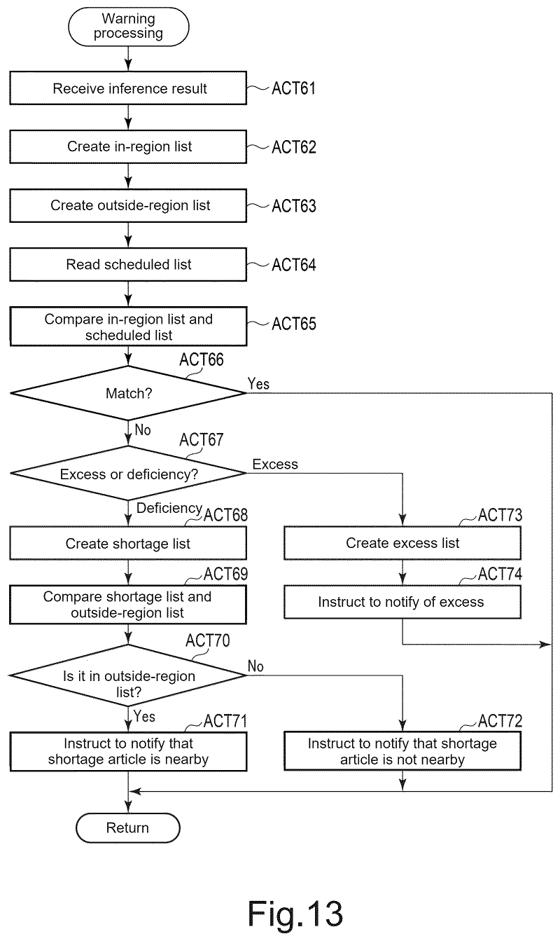

Next, a second operation example of the warning processing shown in FIG. 6 will be described with reference to FIG. 13. FIG. 13 is a flowchart showing the second operation example of the warning processing shown in FIG. 6.

First, in ACT61, the warning device 70 receives an inference result from the inferring device 50.

Next, in ACT62, the warning device 70 creates an in-region list on the basis of the inference result received from the inferring device 50. The in-region list is a list of identification codes of the wireless tags 90 inferred to be in the disposed region by the inferring device 50.

Subsequently, in ACT63, the warning device 70 creates an outside-region list on the basis of the inference result received from the inferring device 50. The outside-region list is a list of identification codes of the wireless tags 90 inferred to be outside the disposed region by the inferring device 50.

Next, in ACT64, the warning device 70 reads a scheduled list. The scheduled list is a list of identification codes of the articles 80 to be disposed in the disposed region for shipment. The scheduled list is given in advance.

Next, the warning device 70 compares the in-region list and the scheduled list in ACT65, and determines whether or not the identification codes of the articles 80 in the scheduled list and the identification codes of the wireless tags 90 in the in-region list (i.e., identification codes of the articles 80) match in ACT66.

In the case where the result of the determination in ACT66 is that the scheduled list and the in-region list do not match (in the case of No in ACT66), the warning device 70 determines the excess or deficiency of the identification codes in the in-region list with respect to the identification codes in the scheduled list in ACT67.

In the case where the result of the determination in ACT67 is that there is a shortage of identification codes in the in-region list with respect to the identification codes in the scheduled list (in the case of Deficiency in ACT67), the warning device 70 extracts an identification code that is included in the scheduled list but is not included in the in-region list to create a shortage list that is a list of identification codes of missing articles 80 in ACT68.

Next, the warning device 70 compares the shortage list and the outside-region list in ACT69, and determines whether or not each identification code in the shortage list is in the outside-region list in ACT70.

In the case where the result of the determination in ACT70 is that the identification code in the shortage list is in the outside-region list (in the case of Yes in ACT66), the warning device 70 instructs the terminal 60 to notify that the article 80 (missing article) corresponding to the identification code is nearby in ACT71. For this purpose, the warning device 70 transmits, to the terminal 60, an instruction to display a warning message indicating that a missing article is nearby. In ACT15 (terminal processing), the terminal 60 displays the warning message in accordance with the instruction to display a warning message received from the warning device 70.

The possible causes of that the identification code in the scheduled list is in the outside-region list include forgetting to take the article 80.

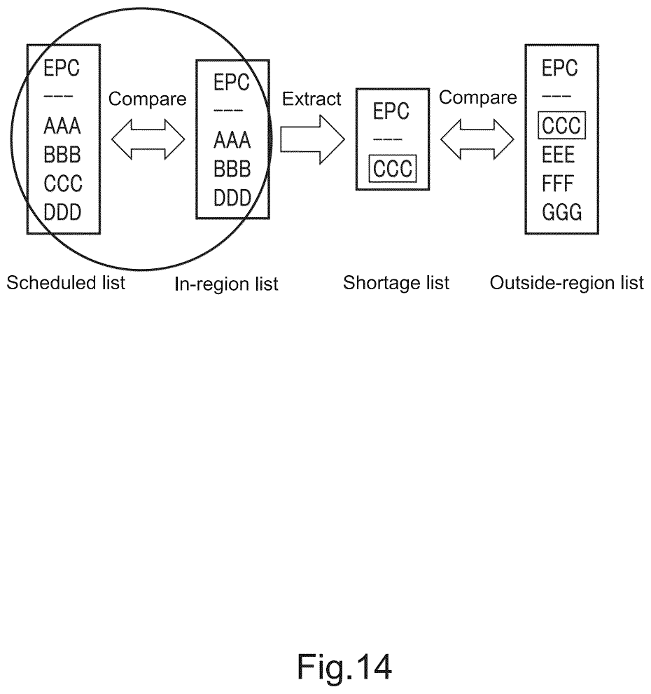

A flow of an example of the comparison between the scheduled list and the in-region list in ACT65, the creation of a shortage list in ACT68, and the comparison between the shortage list and an outside-region list in ACT69 is schematically shown in FIG. 14. In FIG. 14, the identification codes are shown as EPCs.

FIG. 14 shows an example in which the EPC “CCC” that is included in the scheduled list but is not included in the in-region list is extracted as a result of the comparison between the scheduled list and the in-region list, a shortage list including the EPC “CCC” is created, and the EPC “CCC” in the shortage list is included in the outside-region list.

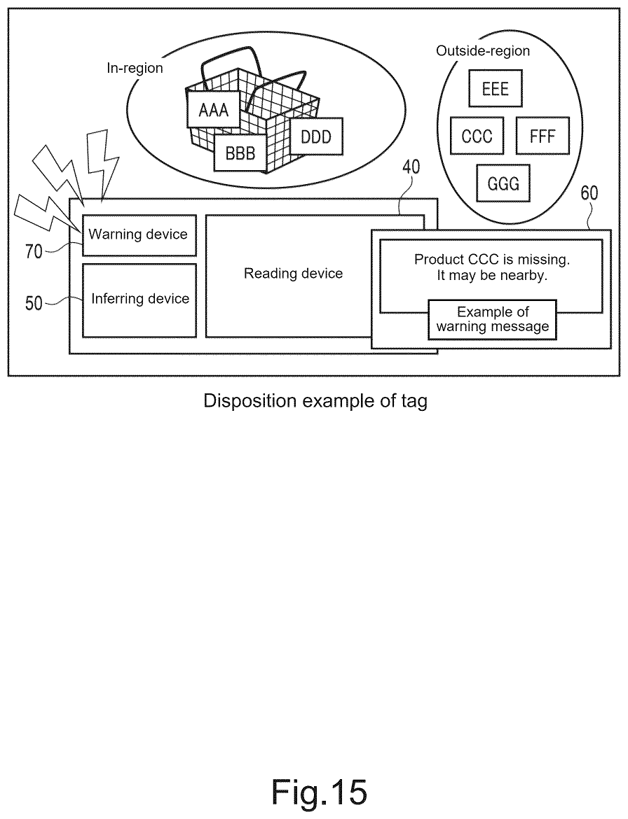

An example of the disposition of wireless tags and the warning message corresponding to the example shown in FIG. 14 is schematically shown in FIG. 15. FIG. 15 shows an example in which the article 80 with the EPC “CCC” is outside the disposed region and the terminal 60 displays the warning message “Product CCC is missing. It may be nearby.” in accordance with an instruction from the warning device 70.

In the case where the result of the determination in ACT70 is that the identification code in the shortage list is not in the outside-region list (in the case of No in ACT66), the warning device 70 instructs the terminal 60 to notify that an article (missing article) corresponding to the identification code is not nearby in ACT72. For this purpose, the warning device 70 transmits, to the terminal 60, an instruction to display a warning message indicating that no missing article is nearby. The terminal 60 displays the warning message in accordance with the instruction to display a warning message received from the warning device 70 in ACT15 (terminal processing).

The reasons why the identification code in the scheduled list is not in the outside-region list include a shortage of the article 80.

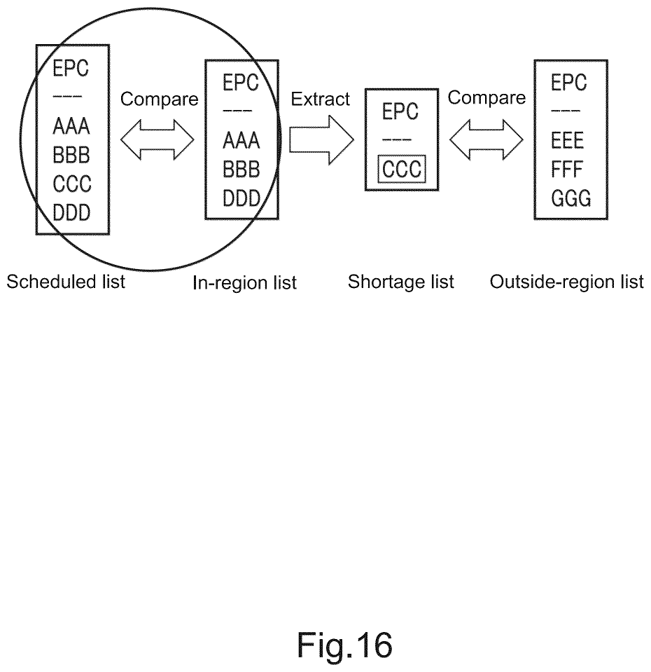

A flow of an example of the comparison between the scheduled list and the in-region list in ACT65, the creation of a shortage list in ACT68, and the comparison between the shortage list and an outside-region list in ACT69 is schematically shown in FIG. 16. In FIG. 16, the identification codes are shown as EPCs.

FIG. 16 shows an example in which the EPC “CCC” that is included in the scheduled list but is not included in the in-region list is extracted as the result of the comparison between the scheduled list and the in-region list, a shortage list including the EPC “CCC” is created, and the EPC “CCC” in the shortage list is not included in the outside-region list.

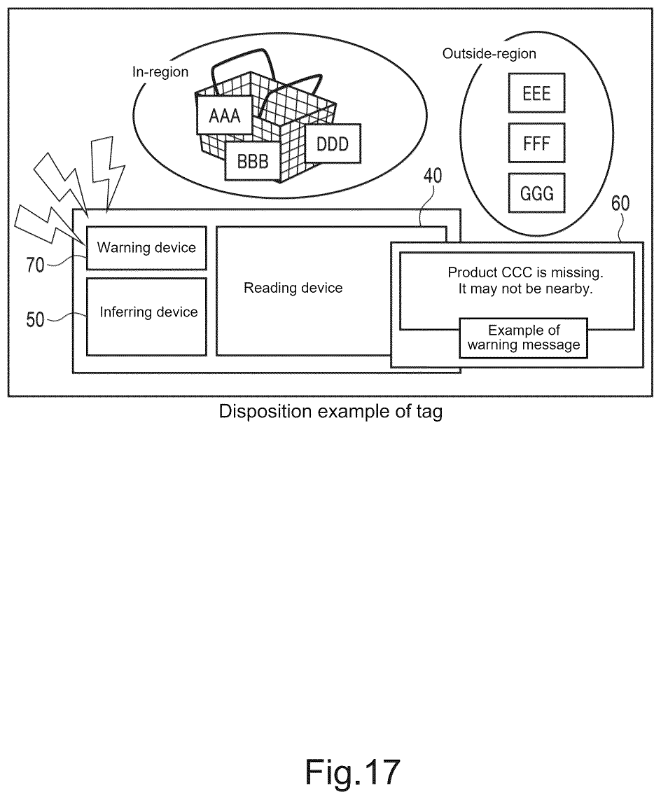

An example of the disposition of wireless tags and the warning message corresponding to the example shown in FIG. 16 is schematically shown in FIG. 17. FIG. 17 shows an example in which the article 80 with the EPC “CCC” is neither in the disposed region nor outside the disposed region and the terminal 60 displays the warning message “Product CCC is missing. It may not be nearby.” in accordance with an instruction from the warning device 70.

In the case where the result of the determination in ACT67 is that there is an excess identification code in the in-region list with respect to the identification codes in the scheduled list (in the case of excess in ACT67), the warning device 70 extracts an identification code that is not included in the scheduled list but is included in the in-region list and creates an excess list that is a list of identification codes of the excess articles 80 in ACT73.

Next, in ACT74, the warning device 70 instructs the terminal 60 to notify that there is an excess article corresponding to the identification code in the excess list in the disposed region. For this purpose, the warning device 70 transmits, to the terminal 60, an instruction to display a warning message indicating that there is an excess article 80 in the disposed region. In ACT15 (terminal processing), the terminal 60 displays the warning message in accordance with the instruction to display a warning message received from the warning device 70.

The possible causes of that there is an excess identification code in the in-region list with respect to the identification codes in the scheduled list include a mistake in picking the article 80.

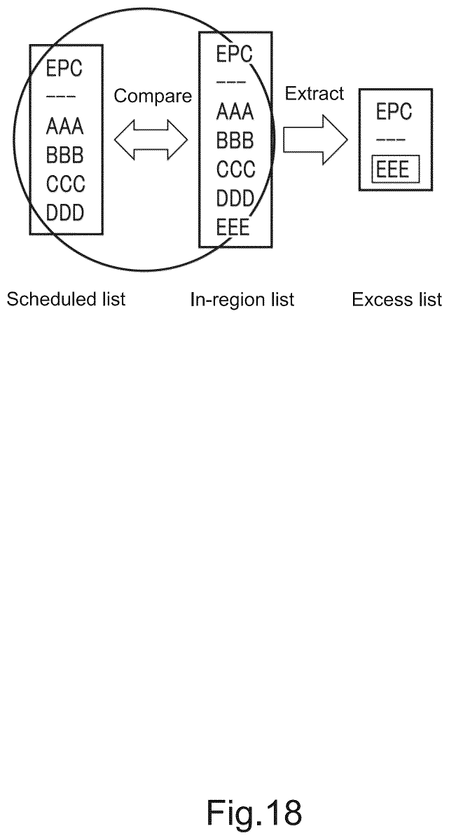

A flow of an example of the comparison between the scheduled list and the in-region list in ACT65 and the creation of an excess list in ACT73 is schematically shown in FIG. 18. In FIG. 18, the identification codes are shown as EPCs.

FIG. 18 shows an example in which the EPC “EEE” that is not included in the scheduled list but is included in the in-region list is extracted as a result of the comparison between the scheduled list and the in-region list and an excess list including the EPC “EEE” is created.

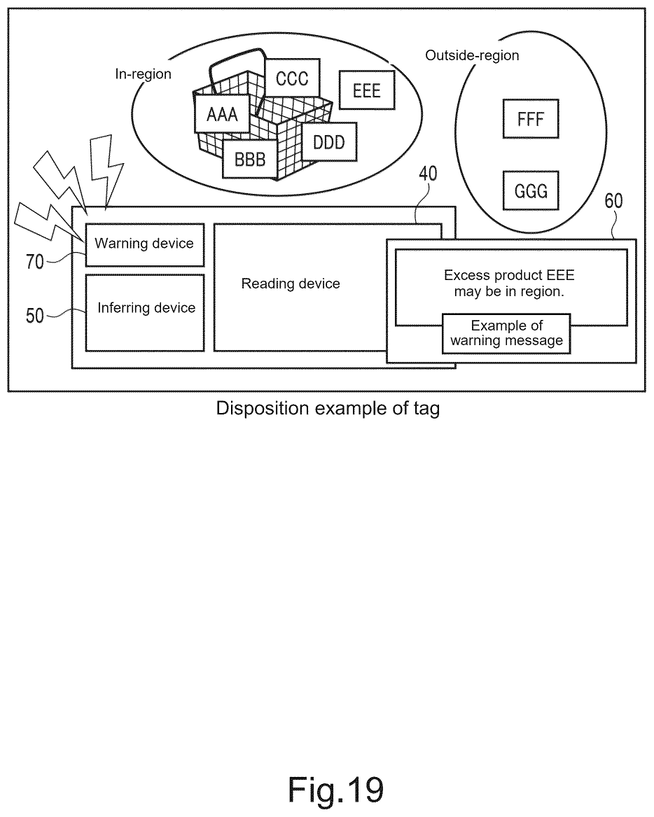

An example of the disposition of wireless tags and the warning message corresponding to the example shown in FIG. 18 is schematically shown in FIG. 19. FIG. 19 shows an example in which an excess article 80 with the EPC “EEE” is in the disposed region and the terminal 60 displays the warning message “Excess product EEE may be in region.” in accordance with an instruction from the warning device 70.

In the case where the result of the determination in ACT66 is that the scheduled list and the in-region list match (in the case of Yes in ACT66), the warning device 70 ends the warning processing without performing the processing in ACT67 to ACT74. In this case, the terminal 60 performs no processing in ACT15 (terminal processing).

### (Second Operation Example of Wireless Tag Communication Apparatus)

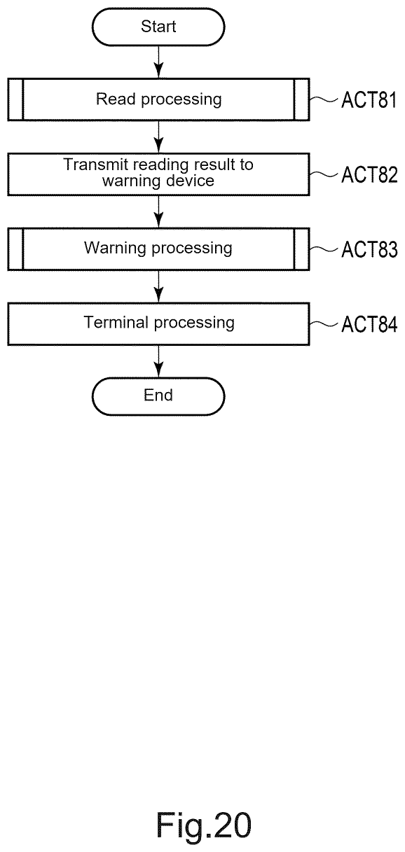

Next, a second operation example of the wireless tag communication apparatus 10 will be described with reference to FIG. 20. FIG. 20 is a flowchart showing the second operation example of the wireless tag communication apparatus 10. The second operation example shown in FIG. 20 is an operation example in which warning processing is performed on the basis of the reading result of the reading device 40. The flowchart shown in FIG. 20 is started by, for example, inputting an operation start instruction to the terminal 60.

In ACT81, the reading device 40 performs read processing. The details of the read processing in ACT81 are the same as the read processing (ACT11) in the first operation example. The reading device 40 reads the tag data of the wireless tag 90 at a plurality of relative positions of the antenna 20 to the wireless tag 90.

In ACT82, the reading device 40 transmits the read tag data of the wireless tag 90 to the warning device 70.

In ACT83, the warning device 70 performs warning processing. For example, the warning device 70 creates a read list that is a list of identification codes of the wireless tag 90 read by the reading device 40 (i.e., identification codes of the article 80), compares the scheduled list and the read list, and transmits, to the terminal 60, an instruction to display a warning message in accordance with the comparison result.

In ACT85, the terminal 60 performs terminal processing. For example, the terminal 60 displays a warning message in accordance with the instruction display a warning message received from the warning device 70.

### (Operation Example of Warning Processing)

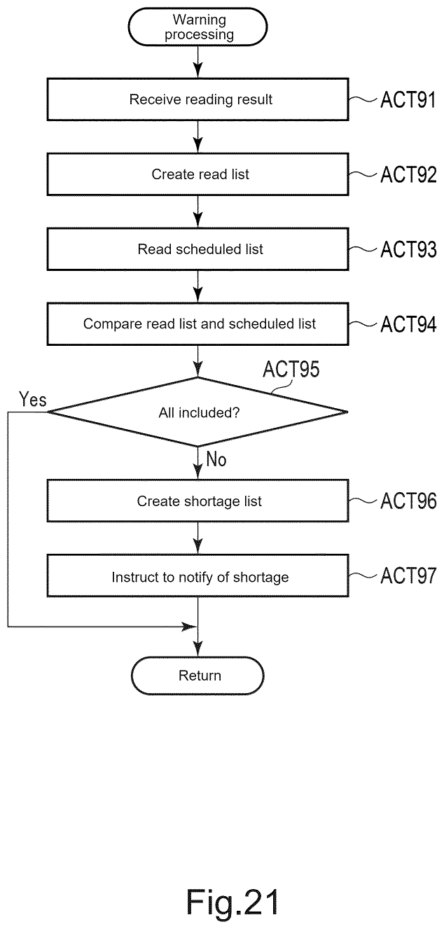

Next, an operation example of the warning processing shown in FIG. 20 will be described with reference to FIG. 21. FIG. 21 is a flowchart showing an operation example of the warning processing shown in FIG. 20.

First, in ACT91, the warning device 70 receives a reading result from the reading device 40.

Next, in ACT92, the warning device 70 creates a read list on the basis of the reading result received from the reading device 40. The read list is a list that is a list of identification codes of the wireless tag 90 read by the reading device 40.

Subsequently, in ACT93, the warning device 70 reads a scheduled list. The scheduled list is a list of identification codes of the articles 80 to be disposed in the disposed region for shipment. The scheduled list is given in advance.

Next, the warning device 70 compares the read list and the scheduled list in ACT94, and determines whether or not the identification codes of the articles 80 in the scheduled list are all included in the identification codes of the wireless tags 90 in the read list (i.e., identification codes of the articles 80) in ACT95.

In the case where the result of the determination in ACT95 is that not all of the identification codes in the scheduled list are included in the read list (in the case of No in ACT95), the warning device 70 extracts an identification code that is included in the scheduled list but is not included in the read list to create a shortage list that is a list of identification codes of missing articles 80 in ACT96.

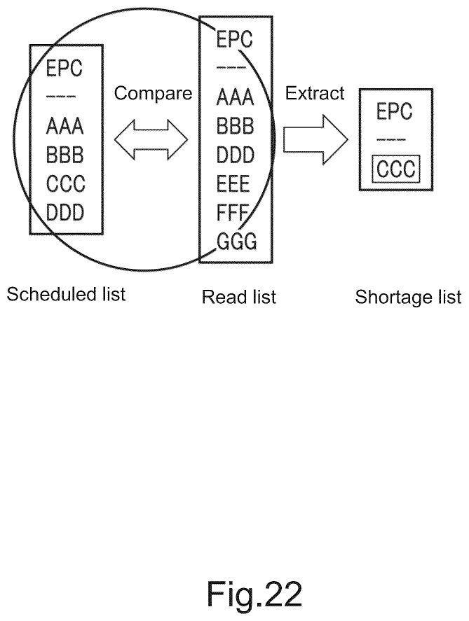

A flow of an example of the processing from the comparison between the read list and the scheduled list in ACT94 to the creation of a shortage list in ACT96 is schematically shown in FIG. 22. In FIG. 22, the identification codes of the wireless tags 90 are shown as EPCs.

FIG. 22 shows an example in which the EPC “CCC” that is included in the scheduled list but is not included in the read list is extracted as a result of the comparison between the read list and the scheduled list and a shortage list including the EPC “CCC” is created.

In ACT97, the warning device 70 instructs the terminal 60 to notify of a shortage. For this purpose, the warning device 70 transmits, to the terminal 60, an instruction to display a warning message indicating a shortage of the article 80 corresponding to the identification code in the shortage list. In ACT15 (terminal processing), the terminal 60 displays a warning message in accordance with the instruction display a warning message received from the warning device 70.

The possible causes of that the identification code in the scheduled list is not included in the read list include the wireless tag 90 corresponding to the identification code is not included in the wireless tag 90 that responds to the radio wave transmitted from the wireless tag communication apparatus 10. The reason for this may be, for example, a shortage of the article 80 corresponding to the identification code.

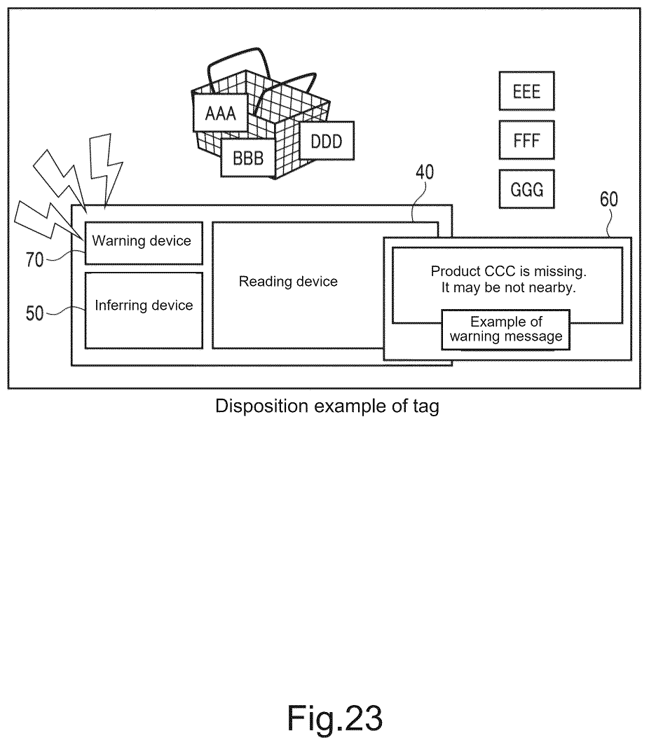

An example of the disposition of wireless tags and the warning message corresponding to the example shown in FIG. 22 is schematically shown in FIG. 23. FIG. 23 shows an example in which the article 80 with the EPC “CCC” is not included in the wireless tag 90 that responds to the radio wave transmitted from the wireless tag communication apparatus 10 and the terminal 60 displays the warning message “Product CCC is missing. It may not be nearby.” in accordance with an instruction from the warning device 70.

In the case where the result of the determination in ACT95 is that the identification codes in the scheduled list are all included in the read list (in the case of Yes in ACT95), the warning device 70 ends the warning processing without instructing the creation of a shortage list in ACT96 and the notification of a shortage in ACT97. In this case, the terminal 60 performs no processing in ACT15 (terminal processing).

### (First Modification of Warning Processing)

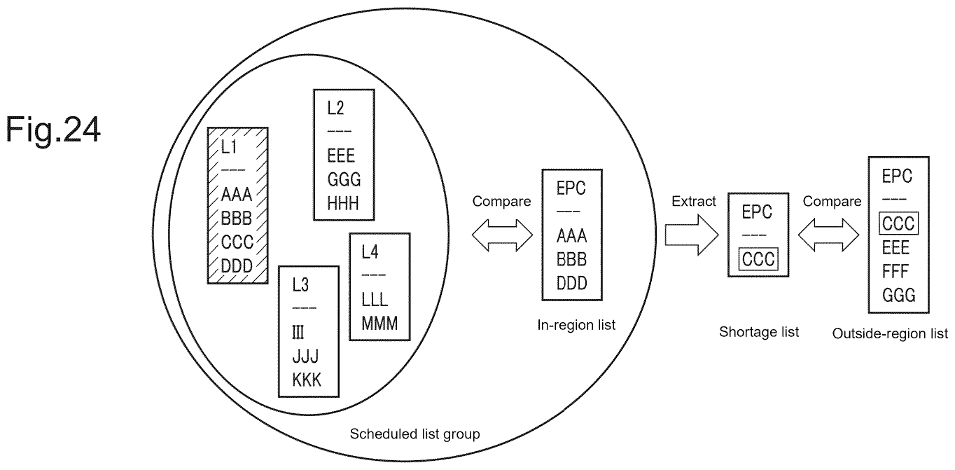

Next, a first modification of the warning processing in the first operation example of the wireless tag communication apparatus 10 will be described with reference to FIG. 24. FIG. 24 is a diagram schematically showing the first modification of the warning processing.

In this modification, instead of one scheduled list being given in advance, a scheduled list group including a plurality of scheduled lists is given in advance. The identification data of the plurality of scheduled lists do not overlap with each other. That is, the plurality of scheduled lists does not contain the same identification data.

The warning device 70 compares the identification data of the in-region list with each scheduled list in the scheduled list group, selects a scheduled list containing the identification data of the in-region list from the scheduled list group, and reads the scheduled list. In the example shown in FIG. 24, the warning device 70 selects a scheduled list L1 including the EPC “AAA” in the in-region list from the scheduled list group and reads the scheduled list L1.

After that, as described above, the warning device 70 extracts an identification code that is included in the scheduled list but is not included in the in-region list to create a shortage list, compares the shortage list and the outside-region list, and instructs the terminal 60 to display a warning message in accordance with the comparison result.

FIG. 24 shows an example in which the EPC “CCC” that is included in the scheduled list L1 but is not included in the in-region list is extracted as a result of the comparison between the in-region list and the scheduled list L1, a shortage list is created, and the EPC “CCC” in the shortage list is included in the outside-region list.

### (Second Modification of Warning Processing)

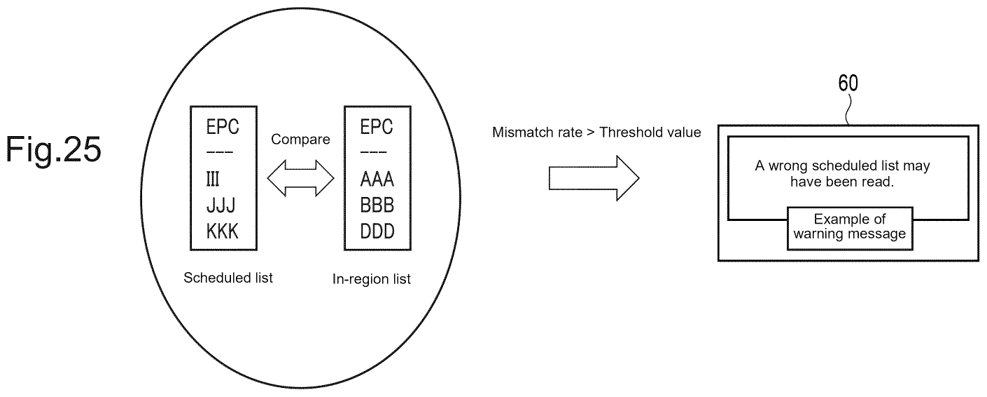

Next, a second modification of the warning processing in the first operation example of the wireless tag communication apparatus 10 will be described with reference to FIG. 25. FIG. 25 is a diagram schematically showing the second modification of the warning processing.

In this modification, the warning device 70 calculates the mismatch rate of the identification code (EPC) between the scheduled d list and the in-region list when comparing the scheduled list and the in-region list. In the case where the mismatch rate of the identification code (EPC) between the scheduled list and the in-region list exceeds a threshold value (e.g., 20%), the warning device 70 instructs the terminal 60 to make a notification indicating a misread of the scheduled list.

FIG. 25 shows an example in which the mismatch rate of the identification code (EPC) between the scheduled list and the in-region list exceeds the threshold value and the terminal 60 displays the warning message “A wrong scheduled list may have been read.” in accordance with an instruction from the warning device 70.

### (Third Modification of Warning Processing)

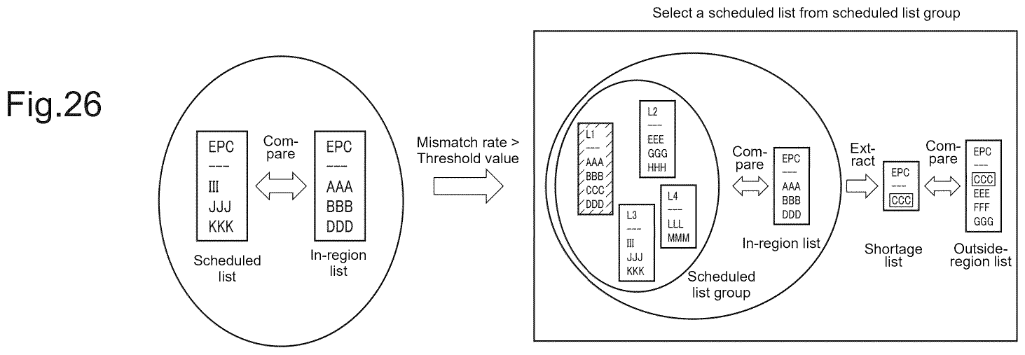

Next, a third modification of the warning processing in the first operation example of the wireless tag communication apparatus 10 will be described with reference to FIG. 26. FIG. 26 is a diagram schematically showing the third modification of the warning processing.

In this modification, the warning device 70 calculates the mismatch rate of the identification code (EPC) between the scheduled list and the in-region list when comparing the scheduled list and the in-region list, similarly to the second modification of the warning processing. In the case where the mismatch rate of the identification code (EPC) between the scheduled list and the in-region list exceeds a threshold value (e.g., 20%), the warning device 70 performs the operation of the first modification of the warning processing. That is, the warning device 70 compares the identification data of the in-region list with each scheduled list in the scheduled list group, selects a scheduled list containing the identification data of the in-region list from the scheduled list group, and reads the scheduled list.

### Effects

The wireless tag communication apparatus 10 according to the embodiment reads, by the reading device 40, the tag data of the wireless tag 90 at a plurality of relative positions of the antenna 20 to the wireless tag 90, infers, by the inferring device 50, whether or not each wireless tag 90 is in the disposed region, and performs, by the warning device 70, warning processing to alert in the case where the reading or inference has failed. This allows the user to know that the reading or inference has failed.

For example, the warning device 70 compares the scheduled list and the in-region list and performs, in the case where the scheduled list and the in-region list do not match, warning processing indicating a possibility that the article 80 to be shipped is different from any of the articles 80 in the scheduled list. Further, the warning device 70 performs, in the case where an identification code that is included in the scheduled list is not included in the in-region list, warning processing indicating a shortage of the article 80. Further, the warning device 70 performs, in the case where an identification code that is included in the scheduled list is included in the outside-region list, warning processing indicating a possibility that the missing article 80 is nearby. This allows the user to easily understand the status, causes, countermeasures, and the like for the reading and inference.

The program according to this embodiment may be transferred while being stored in an electronic apparatus or may be transferred while being not stored in an electronic apparatus. In the latter case, the program may be transferred via a network or may be transferred while being stored in a storage medium. The storage medium is a non-temporary tangible medium. The storage medium is a computer-readable medium. The storage medium only needs to be a medium that is capable of storing a program and can be read by a computer, such as a CD-ROM and a memory card, and its form is not limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless tag communication apparatus, comprising:
an antenna configured to read a radio wave transmitted from a wireless tag attached to an article;
a reading device configured to read, on a basis of the radio wave received by the antenna, tag data of the wireless tag including an identification code of the article; and
a warning device configured to perform, on a basis of a scheduled list that is a list of identification codes of articles to be disposed in a disposed region for shipment and a read list that is a list of identification codes of articles read by the reading device, warning processing indicating a possibility that an article disposed in the disposed region is different from any of the articles corresponding to the identification codes in the scheduled list.

2. The wireless tag communication apparatus according to claim 1, further comprising
an inferring device configured to infer, from the tag data of the wireless tag at a plurality of relative positions of the antenna to the wireless tag, whether or not the article to which the wireless tag is attached is in the disposed region using a trained model by machine learning.

3. The wireless tag communication apparatus according to claim 2, further comprising
a relative position change device configured to change a relative position of the antenna to the wireless tag.

4. The wireless tag communication apparatus according to claim 2, wherein
the warning device is further configured to create an in-region list that is a list of identification codes of articles inferred to be in the disposed region by the inferring device.

5. The wireless tag communication apparatus according to claim 4, wherein
the warning device is further configured to compare the scheduled list and the in-region list and perform warning processing where the scheduled list and the in-region list do not match.

6. The wireless tag communication apparatus according to claim 5, wherein
the warning device is further configured to
extract an identification code that is included in the scheduled list but is not included in the in-region list to create a shortage list that is a list of identification codes of missing articles, and
perform warning processing indicating a shortage of the article corresponding to the identification code in the shortage list.

7. The wireless tag communication apparatus according to claim 6, wherein
the inferring device is further configured to infer, from the tag data of the wireless tag read by the reading device, whether or not the article to which the wireless tag is attached is outside the disposed region using the trained model.

8. The wireless tag communication apparatus according to claim 7, wherein
the inferring device is further configured to
create an outside-region list that is a list of identification codes of articles inferred to be outside the disposed region, and
compare the shortage list and the outside-region list and perform, where the identification code in the shortage list is included in the outside-region list, warning processing indicating a possibility that the article corresponding to the identification code in the shortage list, which is included in the outside-region list, is nearby.

9. The wireless tag communication apparatus according to claim 1, wherein
the inferring device is further configured to perform, where at least one of the identification codes in the scheduled list is not included in the read list, warning processing indicating a shortage of the article corresponding to the identification code that is included in the scheduled list but is not included in the read list.

10. A wireless tag communication method, comprising:
receiving, by an antenna, a radio wave transmitted from a wireless tag;
reading, by a reading device, tag data including an identification code of the wireless tag on a basis of the radio wave received by the antenna; and
performing, on a basis of a scheduled list that is a list of identification codes of articles to be disposed in a disposed region for shipment and a read list that is a list of read identification codes of articles, warning processing indicating a possibility that an article disposed in the disposed region is different from any of the articles corresponding to the identification codes in the scheduled list.
